(19) United States
(12) Patent Application Publication
(10) Pub. No.: US 2014/0073181 A1
(43) Pub. Date: Mar. 13, 2014

(54) GROUND UNIT AND ELECTRICAL CONNECTOR USING SAME

(71) Applicant: Fenny YANG, New Taipei City (TW)

(72) Inventor: Fenny YANG, New Taipei City (TW)

(73) Assignee: ALL BEST ELECTRONICS CO., LTD.

(21) Appl. No.: 13/606,181

(22) Filed: Sep. 7, 2012

(51) Int. Cl. H01R 13/648

(52) U.S. Cl. 439/607.01

(57) ABSTRACT

A ground unit is applied to an electrical connector having a plurality of transmission units. The ground unit includes a first carrier plate and a conductive grounding member arranged in the first carrier plate and having a plurality of first and second ground terminals. In the electrical connector, the first ground terminals of the ground units are corresponding to a plurality of first transmission terminals of the transmission units in position and shape, and the second ground terminals of the ground units and a plurality of second transmission terminals of the transmission units are configured for inserting onto a circuit board. Thus, the ground units provide EMI shielding to the transmission units in the electrical connector to effectively prevent EMI and crosstalk, and enable the electrical connector to have upgraded signal transmission rate and quality as well as high heat dissipation efficiency.

### FIELD OF TECHNOLOGY

The present invention relates to a ground unit and an electrical connector using same.

### BACKGROUND

An electrical connector is used to achieve electrical connection between two electronic devices or two electronic interfaces, such as between two circuit boards or between an electronic device and a circuit board, so that data or signal can be transmitted therebetween.

A conventional electrical connector usually has a case, in which a plurality of transmission units and a plurality of ground units are arranged. Each of the transmission units includes a plurality of transmission members for signal transmission. The performance of the electrical connector is influenced by the length, shape and physical properties of the transmission members. Particularly, adjacent conductive terminals in an electrical connector for high-frequency and high-speed transmission tend to affect one another to produce, for example, crosstalk, electromagnetic interference (EMI) or transmission errors. Therefore, ground units must be properly arranged in the electrical connector in order to reduce the EMI produced by signal terminals during signal transmission.

A first conventional ground unit applied to the electrical connector includes a plastic carrier plate and a plurality of ground members arranged in the plastic carrier plate. These ground members are metal members spaced from one another, and are corresponding to the transmission members of the transmission units in shape, position and number, so as to provide EMI shielding to the transmission members and reduce the mutual signal interference between the transmission units.

However, since the ground members in the first conventional ground unit are spaced metal members in the form of a bent strip each, they can only provide limited shielding areas to the transmission members. As a result, the electrical connector using such conventional ground members has relatively poor EMI protection and crosstalk prevention effects.

A second conventional ground unit applied to the electrical connector includes a plastic carrier plate and one single metal member arranged in the plastic carrier plate to serve as a ground member for providing EMI shielding to the transmission members. However, this type of conventional ground unit does not include terminals for connecting to an external transmission cable. That is, this type of conventional ground unit only provides shielding to the transmission members but does not allow the forming of a ground circuit between an external electronic device connected to the electrical connector and the ground member. As a result, the electrical connector using the second conventional ground unit still has limited EMI protection and crosstalk prevention effects.

### SUMMARY

A primary object of the present invention is to provide a ground unit that is applied to an electrical connector to provide enhanced EMI protection and crosstalk prevention, so that the electrical connector can have upgraded signal transmission rate and good heat dissipation efficiency.

Another object of the present invention is to provide an electrical connector, of which a plurality of ground units has structural arrangements enabling enhanced EMI protection and crosstalk prevention for the electrical connector to have upgraded signal transmission rate; and the ground units also transfer heat energy produced by the electrical connector during operation thereof to an outer side of the electrical connector to achieve good heat dissipation effect.

To achieve the above and other objects, the ground unit according to the present invention is usable with a plurality of transmission units to form an electrical connector, and includes a first carrier plate and a conductive grounding member. The conductive grounding member is arranged in the first carrier plate and has a plurality of first ground terminals and a plurality of second ground terminals.

According to an embodiment of the ground unit, the first ground terminals of the ground unit are located corresponding to a plurality of first transmission terminals of the transmission units, and the second ground terminals of the ground unit and a plurality of second transmission terminals of the transmission units are configured for inserting onto a circuit board.

According to an embodiment of the ground unit, the transmission units respectively include a plurality of transmission members arranged in a second carrier plate, and the transmission members respectively have a bent body with two opposite ends projected from the second carrier plate to form the first transmission terminals and the second transmission terminals; and the conductive grounding member in the first carrier plate of each ground unit has a surface area larger than an area defined by the transmission members arranged in the second carrier plate of each transmission unit.

According to an embodiment of the ground unit, the first ground terminals are identical to the first transmission terminals in shape, and are projected from one side of the first carrier plate.

According to an embodiment of the ground unit, the conductive grounding member includes at least one mounting section for connecting the conductive grounding member to the first carrier plate. And, the mounting section can be an opening, a recess, a protrusion or a flange formed on the conductive grounding member.

According to an embodiment of the ground unit, the conductive grounding member includes at least one ground coupling head, the first carrier plate includes at least one first notch, and the ground coupling head is projected from the first carrier plate to locate in the first notch.

To achieve the above and other objects, the electrical connector according to the present invention includes a case, a plurality of transmission units, and a plurality of ground units. The transmission units are arranged in the case and respectively include a plurality of first transmission terminals and a plurality of second transmission terminals; and the second transmission terminals are configured for inserting onto a circuit board. The ground units are arranged in the case and respectively include a first carrier plate and a conductive ground member. The conductive ground member is arranged in the first carrier plate and has a plurality of first ground terminals and a plurality of second ground terminals. The first ground terminals are located corresponding to the first transmission terminals, and the second ground terminals are configured for inserting onto the circuit board.

According to an embodiment of the electrical connector, the first ground terminals are projected from the first carrier plates and are identical to the first transmission terminals in shape, so that the first ground terminals and the first transmission terminals together constitute an electrical connection port of the electrical connector.

According to an embodiment of the electrical connector, the transmission units respectively include a plurality of transmission members arranged in a second carrier plate, and the transmission members respectively have a bent body with two opposite ends projected from the second carrier plate to form the first transmission terminals and the second transmission terminals; and the conductive grounding member in the first carrier plate of each ground unit has a surface area larger than an area defined by the transmission members arranged in the second carrier plate of each transmission unit.

According to an embodiment of the electrical connector, the conductive grounding members respectively include at least one mounting section for connecting the conductive grounding members to the first carrier plates. And, the mounting section can be an opening, a recess, a protrusion or a flange formed on each of the conductive grounding members.

According to an embodiment of the electrical connector, the ground units and the transmission units are so arranged that there are two transmission units located side by side between two ground units, and the second ground terminals of the ground units and the second transmission terminals of the transmission units are offset from one another.

According to an embodiment of the electrical connector, the electrical connector further includes at least one coupling unit coupled to the ground units.

According to an embodiment of the electrical connector, the conductive grounding members respectively include at least one ground coupling head, and the first carrier plates respectively include at least one first notch; and the ground coupling heads are projected from the first carrier plates to locate in the first notches for coupling to the coupling unit.

According to an embodiment of the electrical connector, the second carrier plates respectively include at least one second notch, and the second notches are corresponding to the first notches in position for receiving the coupling unit therein; and the coupling unit includes a plurality of insertion slots. The ground coupling heads of the conductive grounding members are inserted into the insertion slots to couple the ground units to the at least one coupling unit.

In brief, the ground unit according to the present invention provides effective EMI protection and crosstalk prevention as well as good heat dissipation effect; and the electrical connector using the ground units according to the present invention can also have the advantages of effective EMI protection and crosstalk prevention to enable upgraded signal transmission rate and quality as well as high heat dissipation efficiency thereof.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a preferred embodiment of a ground unit according to the present invention;

FIG. 2 is a side view of the ground unit of FIG. 1;

FIG. 3 is an exploded perspective view of a preferred embodiment of an electrical connector according to the present invention, wherein the electrical connector uses the ground unit shown in FIG. 1;

FIG. 4 is an assembled perspective view of the electrical connector of FIG. 3 before being inserted onto a circuit board; and

FIG. 5 is a side view showing the electrical connector of FIG. 4 having been inserted onto the circuit board.

### DETAILED DESCRIPTION

The present invention will now be described with some preferred embodiments thereof and with reference to the accompanying drawings. For the purpose of easy to understand, elements that are the same in the preferred embodiments are denoted by the same reference numerals.

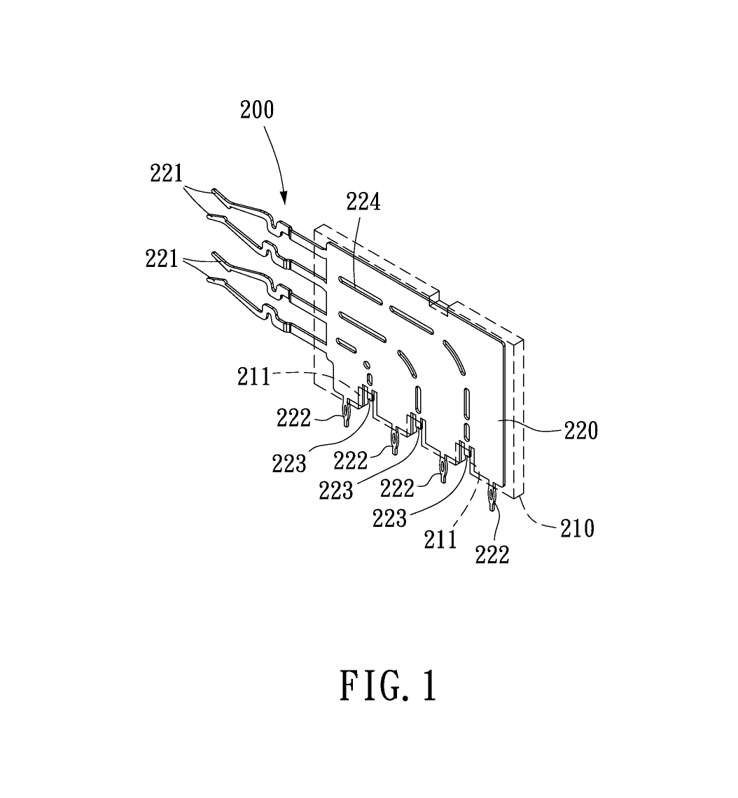

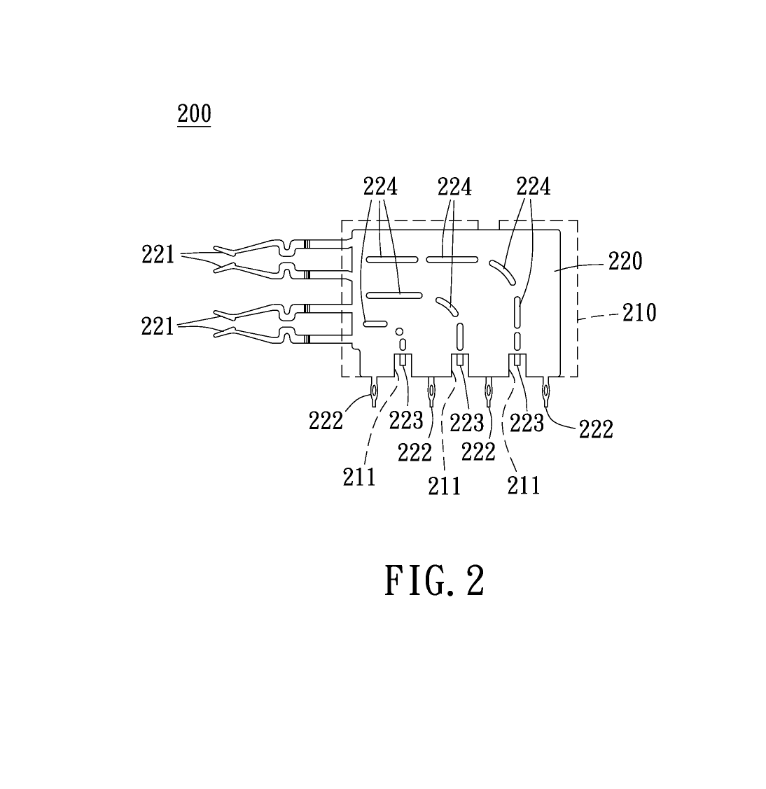

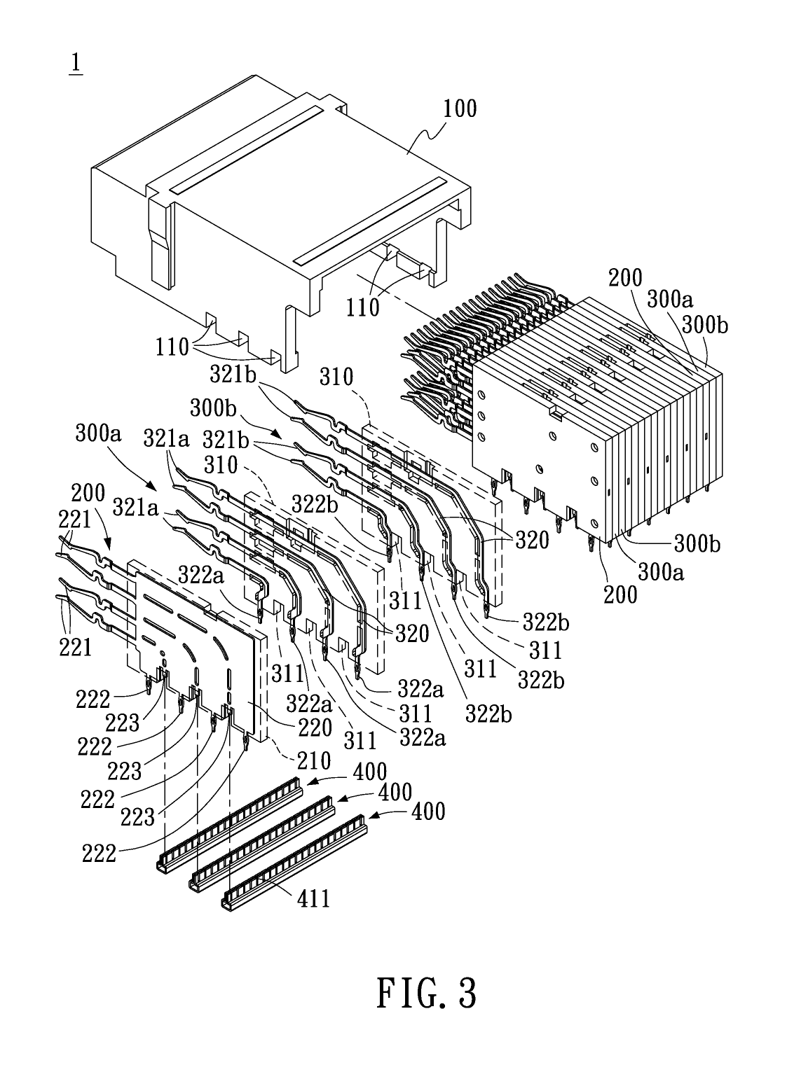

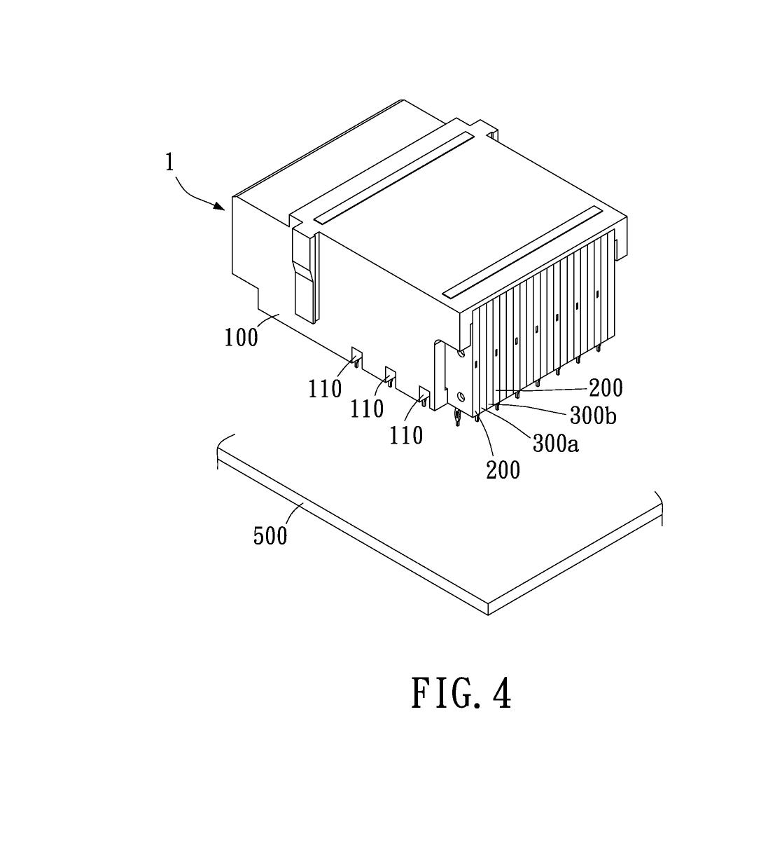

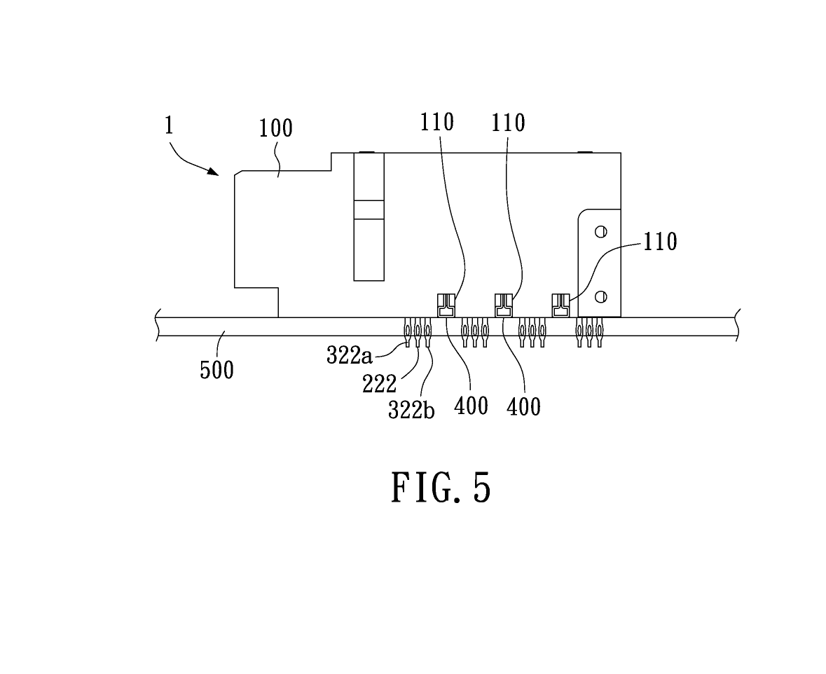

Please refer to FIGS. 1 and 2 that are perspective and side views, respectively, of a preferred embodiment of a ground unit 200 according to the present invention, and to FIG. 3 that is an exploded perspective view of a preferred embodiment of an electrical connector 1 according to the present invention that uses the ground unit 200 of FIG. 1. As shown, a plurality of ground units 200 and a plurality of transmission units 300a, 300b are assembled together to form the electrical connector 1. As can be seen in FIGS. 1 and 2, the ground unit 200 includes a first carrier plate 210 and a conductive grounding member 220. The conductive grounding member 220 is arranged in the first carrier plate 210 and has a plurality of first ground terminals 221 and a plurality of second ground terminals 222. As can be seen in FIG. 3, the transmission units 300a, 300b respectively has a plurality of first transmission terminals 321a, 321b and a plurality of second transmission terminals 322a, 322b. The first ground terminals 221 are located corresponding to the first transmission terminals 321a, 321b; and the second ground terminals 222 are provided for inserting onto a circuit board 500 (see FIGS. 4 and 5).

In the illustrated preferred embodiment of the ground unit 200 for the electrical connector 1, the first ground terminals 221 are identical to the first transmission terminals 321a, 321b in shape, and are projected from the first carrier plates 210. When the ground units 200 and the transmission units 300a, 300b are assembled together to form the electrical connector 1, the first ground terminals 221 and the first transmission terminals 321a, 321b are parallelly arranged side by side to constitute a connection port of the electrical connector 1, and an external transmission cable (not shown) can be plugged in the connection port to electrically connect with the electrical connector 1.

Please refer to FIG. 3 along with FIGS. 4 and 5. The transmission units 300a, 300b respectively include a second carrier plate 310 and a plurality of transmission members 320 arranged in the second carrier plate 310. Each of the transmission members 320 has a bent body with two opposite ends projected from the second carrier plate 310 to form the first transmission terminal 321a, 321b and the second transmission terminal 322a, 322b, respectively. The conductive grounding member 220 in the first carrier plate 210 of each ground unit 200 has a surface area larger than an area defined by the transmission members 320 arranged in the second carrier plate 310 of each transmission unit 300a, 300b, so as to provide better EMI shielding and crosstalk prevention effects. The conductive grounding members 220 also have the function of transferring heat energy produced by the electrical connector 1 during operation thereof to an external environment for dissipation. Since the conductive grounding members 220 respectively have a considerably large area to provide increased heat dissipation surface, they can provide the electrical connector 1 with upgraded heat dissipation efficiency. Moreover, when the electrical connector 1 is inserted onto the circuit board 500, the conductive grounding members 220 of the ground units 200 can also transfer the produced heat energy to the circuit board 500, of which a front and a reverse surface also provide additional heat dissipation surfaces to further enhance the heat dissipation efficiency of the electrical connector 1.

Each of the conductive grounding members 220 includes at least one mounting section 224, via which the conductive grounding member 220 is connected to the first carrier plate 210. In the illustrated preferred embodiment of the ground unit 200 as shown in FIGS. 1 and 2, the conductive grounding member 220 includes a plurality of mounting sections 224 in the form of a plurality of openings. When the first carrier plate 210 is formed by molding a plastic material, the molten plastic material can fill the openings to thereby connect the conductive grounding member 220 to the first carrier plate 210. It is understood the at least one mounting section 224 is not necessarily limited to the form of an opening but can be, for example, a recess, a protrusion or a flange formed on the conductive grounding member 220, depending on the manner of forming or manufacturing the first carrier plate 210.

The conductive grounding member further includes at least one ground coupling head 223, and the first carrier plate 210 includes at least one first notch 211. The ground coupling head 223 is projected from the first carrier plate 210 to locate in the first notch 211. In the illustrated preferred embodiment, as shown in FIGS. 1 and 2, each conductive grounding member 220 includes three ground coupling heads 223 and each first carrier plate 210 includes three first notches 211 corresponding to the three ground coupling heads 223 in position. As shown, the ground coupling heads 223 are projected from the first carrier plate 210 to separately locate in the first notches 211. When the ground units 200 and the transmission units 300a, 300b are assembled to form the electrical connector 1, the ground units 200 can be connected to one another by inserting the ground coupling heads 223 into three conductive coupling units 400, which will be described in more details later, to provide the electrical connector 1 with enhanced EMI shielding and grounding effects.

Please refer to FIGS. 3 to 5 at the same time, wherein FIG. 3 is a partially exploded perspective view of the electrical connector 1 according to a preferred embodiment thereof for describing how the ground units 200 and the transmission units 300a, 300b are assembled to form the electrical connector 1, and FIGS. 4 and 5 are perspective and side views, respectively, of the electrical connector 1 before and after being inserted onto a circuit board 500.

The electrical connector 1 includes a case 100, into which the above-mentioned ground units 200 and transmission units 300a, 300b are arranged. The transmission units 300a, 300b respectively include a plurality of first transmission terminals 321a, 321b and a plurality of second transmission terminals 322a, 322b. The second transmission terminals 322a, 322b are configured for inserting onto the circuit board 500. The ground units 200 are arranged in the case 100, and respectively include a first carrier plate 210 and a conductive grounding member 220. The conductive grounding member 220 is located in the first carrier plate 210 and has a plurality of first ground terminals 221 and a plurality of second ground terminals 222. The first ground terminals 221 are corresponding to the first transmission terminals 321a, 321b in location; and the second ground terminals 222 are configured for inserting onto the circuit board 500.

In the illustrated preferred embodiment, as shown in FIG. 3, the first ground terminals 221 are identical to the first transmission terminals 321a, 321b in shape, and are projected from the first carrier plates 210. The first ground terminals 221 and the first transmission terminals 321a, 321b together constitute a connection port (not shown) of the electrical connector 1, and an external transmission cable (not shown) can be plugged in the connection port to electrically connect with the electrical connector 1 for data transmission.

In the electrical connector 1 according to the preferred embodiment thereof, the transmission units 300a, 300b respectively include a second carrier plate 310 and a plurality of transmission members 320 arranged in the second carrier plate 310. The transmission members 320 respectively have a bent body with two opposite ends projected from the second carrier plates 310 to form the first transmission terminals 321a, 321b and the second transmission terminals 322a, 322b. The conductive grounding member 220 in the first carrier plate 210 of each ground unit 200 has a surface area larger than an area defined by the transmission members 320 arranged in the second carrier plate 310 of each transmission unit 300a, 300b, so as to provide better EMI shielding and crosstalk prevention effects. The conductive grounding members 220 also have the function of transferring heat energy produced by the electrical connector 1 during operation thereof to an external environment for dissipation. Since the conductive grounding members 220 respectively have a considerably large area to provide increased heat dissipation surfaces, they can provide the electrical connector 1 with upgraded heat dissipation efficiency. Moreover, when the electrical connector 1 is inserted onto the circuit board 500, the conductive grounding members 220 of the ground units 200 can also transfer the produced heat energy to the circuit board 500, of which a front and a reverse surface also provide additional heat dissipation surfaces to further enhance the heat dissipation efficiency of the electrical connector 1.

For illustrative purpose only, the preferred embodiment of the electrical connector 1 as shown in FIG. 3 has two transmission units 300a, 300b arranged side by side between two ground units 200. Therefore, the conductive grounding members 220, the first ground terminals 221, and the second ground terminals 222 of the ground units 220 provide shielding at two lateral sides of the two adjoining transmission units 300a, 300b when the electrical connector 1 works. That is, during signal transmission via the transmission units 300a, 300b, the transmission members 320, the first transmission terminals 321a, 321b, and the second transmission terminals 322a, 322b of the two juxtaposed transmission units 300a, 300b are shielded by the conductive grounding members 220, the first ground terminals 221 and the second ground terminals 222 of the two adjacent ground units 200 to ensure better EMI shielding and crosstalk prevention effects. It is noted the second ground terminals 222 of the ground units 200 and the second transmission terminals 322a, 322b of the transmission units 300a, 300b are offset from one another.

In addition, the electrical connector 1 further includes at least one coupling unit 400 for coupling to the ground units 200, so that the ground units 200 are electrically connected to one another via the coupling unit 400. More specifically, the conductive grounding members 220 respectively include at least one ground coupling head 223, the first carrier plates 210 respectively include at least one first notch 211, and the ground coupling heads 223 are projected from the first carrier plates 210 to located in the first notches 211; and the coupling unit 400 includes a plurality of insertion slots 411, into which the ground coupling heads 223 are inserted to thereby couple the ground units 200 to the coupling unit 400. Meanwhile, the second carrier plates 310 of the transmission units 300a, 300b respectively include at least one second notch 311, and the second notches 311 are located at positions corresponding to the first notches 211 for receiving the coupling unit 400 therein. Since the ground units 200 are electrically connected to one another via the coupling unit 400, and the first ground terminals 221 and the second ground terminals 222 are electrically connected to an external transmission cable and the circuit board 500, respectively, a ground circuit is formed to enable reduced mutual signal interference between the transmission units 300a, 300b.

As shown in FIGS. 3 to 5, the preferred embodiment of the electrical connector 1 according to the present invention is configured as having three coupling units 400 received in three recesses formed by three first notches 211 on each of the ground units 200 and three second notches 311 on each of the transmission units 300a, 300b. However, it is understood the number, shape and arrangement of the coupling units 400, the first notches 211 and the second notches 311 are not necessarily limited to that shown in the drawings but can be changed in design according to actual application of the electrical connector.

Referring to FIGS. 3 to 5, a plurality of heat outlets 110 can be further provided on the case 100 of the electrical connector 1 at positions corresponding to the first notches 211 and the second notches 311. When the electrical connector 1 is connected to an external transmission cable (not shown), a part of the heat energy produced by the transmission members 320 of the transmission units 300a, 300b during signal transmission is transferred via the ground units 200 and/or the coupling units 400 to the circuit board 500 without accumulating in the electrical connector 1, and other part of the produced heat energy is directly dissipated into a space outside the electrical connector 1 via the heat outlets 110 on the case 100. Therefore, the electrical connector 1 has enhanced heat dissipation effect. According to the present invention, the heat outlets 110 may be in the form of notches or openings without being particularly limited to the shape illustrated in the drawings.

With the above structural arrangement of the conductive grounding members 220 of the ground units 200, it is able to upgrade the EMI protection and reduce the signal interference or crosstalk between the transmission units 300a, 300b to improve the signal transmission performance of the electrical connector 1 according to the present invention. Further, with the conductive grounding members 220, the first ground terminals 221 and the second ground terminals 222 thereof, the ground units 200 for the electrical connector 1 of the present invention can provide largely upgraded heat dissipation effect.

The above-described ground units 200 according to the present invention can be applied to a large number of electrical connectors 1 for use with existing transmission cables of different specifications. In most cases, the only differences between the electrical connectors for use with transmission cables of different specifications are their overall size and the arrangement of the transmission units 300a, 300b. More specifically, the electrical connectors used with transmission cables of different specifications have transmission members different in length and shape, as well as have first and second carrier plates and cases different in shape and size. Nevertheless, all these electrical connectors having different specifications can employ the structure provided by the present invention and utilize the ground units 200 and/or the coupling units 400 to achieve the effect of EMI protection. Therefore, the scope of the present invention covers all kinds of electrical connectors that employ the above-described arrangements.

In brief, the ground unit according to the present invention provides effective EMI protection and crosstalk prevention as well as good heat dissipation effect; and the electrical connector using the ground units according to the present invention can also have the advantages of effective EMI protection and crosstalk prevention to enable upgraded signal transmission rate and quality, as well as high heat dissipation efficiency.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A ground unit being applied to an electrical connector having a plurality of transmission units, comprising:
a first carrier plate; and
a conductive grounding member being arranged in the first carrier plate and having a plurality of first ground terminals and a plurality of second ground terminals.

2. The ground unit as claimed in claim 1, wherein the first ground terminals of the ground unit are located corresponding to a plurality of first transmission terminals of the transmission units, and the second ground terminals of the ground unit and a plurality of second transmission terminals of the transmission units are configured for inserting onto a circuit board.

3. The ground unit as claimed in claim 2, wherein the transmission units respectively include a plurality of transmission members arranged in a second carrier plate, and the transmission members respectively having a bent body with two opposite ends projected from the second carrier plate to form the first transmission terminals and the second transmission terminals; and the conductive grounding member in the first carrier plate of each ground unit having a surface area larger than an area defined by the transmission members arranged in the second carrier plate of each transmission unit.

4. The ground unit as claimed in claim 3, wherein the first ground terminals are identical to the first transmission terminals in shape, and are projected from the first carrier plate.

5. The ground unit as claimed in claim 3, wherein the conductive grounding member includes at least one mounting section, via which the conductive grounding member is connected to the first carrier plate.

6. The ground unit as claimed in claim 5, wherein the at least one mounting section is selected from the group consisting of an opening, a recess, a protrusion and a flange formed on the conductive grounding member.

7. The ground unit as claimed in claim 3, wherein the conductive grounding member includes at least one ground coupling head, the first carrier plate includes at least one first notch, and the ground coupling head is projected from the first carrier plate to locate in the first notch.

8. An electrical connector, comprising:
a case;
a plurality of transmission units being arranged in the case and respectively including a plurality of first transmission terminals and a plurality of second transmission terminals; and
the second transmission terminals being configured for inserting onto a circuit board; and
a plurality of ground units being arranged in the case and respectively including a first carrier plate and a conductive ground member; the conductive ground member being arranged in the first carrier plate and having a plurality of first ground terminals and a plurality of second ground terminals; the first ground terminals being located corresponding to the first transmission terminals, and the second ground terminals being configured for inserting onto the circuit board.

9. The electrical connector as claimed in claim 8, wherein the first ground terminals are projected from the first carrier plates and are identical to the first transmission terminals in shape, so that the first ground terminals and the first transmission terminals together constitute an electrical connection port of the electrical connector.

10. The electrical connector as claimed in claim 9, wherein the transmission units respectively include a plurality of transmission members arranged in a second carrier plate, and the transmission members respectively having a bent body with two opposite ends projected from the second carrier plate to form the first transmission terminals and the second transmission terminals, respectively; and the conductive grounding member in the first carrier plate of each ground unit having a surface area larger than an area defined by the transmission members arranged in the second carrier plate of each transmission unit.

11. The electrical connector as claimed in claim 10, wherein the conductive grounding members respectively include at least one mounting section, via which the conductive grounding member is connected to the first carrier plate.

12. The electrical connector as claimed in claim 11, wherein the at least one mounting section is selected from the group consisting of an opening, a recess, a protrusion and a flange formed on each of the conductive grounding members.

13. The electrical connector as claimed in claim 10, wherein the ground units and the transmission units are so arranged that there are two transmission units located side by side between two ground units, and the second ground terminals of the ground units and the second transmission terminals of the transmission units are offset from one another.

14. The electrical connector as claimed in claim 13, further comprising at least one coupling unit being coupled to the ground units.

15. The electrical connector as claimed in claim 14, wherein the conductive grounding members respectively include at least one ground coupling head, the first carrier plates respectively include at least one first notch, and the ground coupling heads are projected from the first carrier plates to locate in the first notches for coupling to the coupling unit.

16. The electrical connector as claimed in claim 15, wherein the second carrier plates respectively include at least one second notch; and the second notches being corresponding to the first notches in position for receiving the coupling unit therein.

17. The electrical connector as claimed in claim 16, wherein the coupling unit includes a plurality of insertion slots, and the ground coupling heads of the conductive grounding members being inserted into the insertion slots to couple the ground units to the at least one coupling unit.
